(19) United States
(12) Patent Application Publication
(10) Pub. No.: US 2023/0111027 A1
(43) Pub. Date: Apr. 13, 2023

(54) LITHIUM SECONDARY BATTERY AND BATTERY SYSTEM INCLUDING THE SAME

(71) Applicant: SK ON CO., LTD., Seoul (KR)

(72) Inventors: Chang Mook HWANG, Daejeon (KR); Sin Young MOON, Daejeon (KR); Yoon Ji JO, Daejeon (KR)

(21) Appl. No.: 17/961,404

(22) Filed: Oct. 6, 2022

(30) Foreign Application Priority Data
Oct. 8, 2021 (KR) 10-2021-0134075

(51) Int. Cl. H01M 50/105; H01M 10/0587; H01M 50/533; H01M 50/184; H01M 10/48; H01M 50/204

(52) U.S. Cl. CPC H01M 50/105; H01M 10/0587; H01M 50/533; H01M 50/184; H01M 10/48; H01M 50/204; H01M 10/0525

(57) ABSTRACT

A lithium secondary battery according to embodiments of the disclosed technology includes a pouch and an electrode assembly accommodated in the pouch. The pouch includes a first pouch case including a first peripheral portion and a first magnetic unit formed at the first peripheral portion, and a second pouch case including a second peripheral portion and a second magnetic unit formed at the second peripheral portion. The second magnetic unit has an opposite polarity from that of the first magnetic unit, and the second pouch case is sealed with the first pouch case.

### CROSS-REFERENCE TO RELATED APPLICATION

This patent document claims priority to Korean Patent Application No. 10-2021-0134075 filed on Oct. 8, 2021 in the Korean Intellectual Property Office (KIPO), the entire disclosure of which is incorporated by reference herein.

### BACKGROUND

### 1. Field

The technology disclosed in this patent document relates to a lithium secondary battery and a battery system including the same. More particularly, the disclosed technology relates to a lithium secondary battery including a sealing portion and a battery system including the same.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. Further, a battery pack including the secondary battery is being developed and applied to a power source of an eco-friendly vehicle such as a hybrid vehicle.

The secondary battery includes, e.g., a lithium secondary battery, a nickel-cadmium battery, a nickel-hydrogen battery, etc. The lithium secondary battery is highlighted due to high operational voltage and energy density per unit weight, a high charging rate, a compact dimension, etc.

For example, the lithium secondary battery may include an electrode assembly including a cathode, an anode and a separation layer (separator), and an electrolyte immersing the electrode assembly. The lithium secondary battery may further include an outer case having, e.g., a pouch shape for housing the electrode assembly and the electrolyte.

A lithium secondary batteries contains a lithium salt such as LiPF₆ and LiBF₄ in the electrolyte. When fluorine (F) contained in the lithium salt reacts with moisture, fluoric acid (HF) is generated. Fluoric acid accelerates a solvent decomposition reaction in the electrolyte to cause an electrode corrosion. Further, swelling due to a side reaction in the electrolyte may be caused to increase an internal pressure of the battery.

For example, Korean Published Patent Publication No. 2019-0031141 discloses a non-aqueous electrolyte containing a fluoric acid sensing agent. However, the fluoric acid sensing agent has a sensitivity only to fluoric acid, and defects may be caused by a side reaction of the fluoric acid sensing agent. Additionally, a transparent identification unit for visually observing a discoloration of the fluoric acid sensing agent is added to a pouch, thereby degrading mechanical properties of the pouch.

### SUMMARY

According to an aspect of the disclosed technology, there is provided a lithium secondary battery having improved operational reliability and stability.

According to an aspect of the disclosed technology, there is provided a battery system having improved operational reliability and stability.

A lithium secondary battery according to exemplary embodiments of the disclosed technology includes a pouch and an electrode assembly accommodated in the pouch. The pouch includes a first pouch case including a first peripheral portion and a first magnetic unit formed at the first peripheral portion, and a second pouch case including a second peripheral portion and a second magnetic unit formed at the second peripheral portion. The second magnetic unit has an opposite polarity from that of the first magnetic unit. The second pouch case is sealed with the first pouch case.

In some embodiments, the first pouch case and the second pouch case may be combined with each other so that the first magnetic unit and the second magnetic unit may face each other.

In some embodiments, the first pouch case and the second pouch case may include a first accommodating portion and a second accommodating portion, respectively, which protrude to an outside of the pouch to accommodate the electrode assembly.

In some embodiments, the first magnetic unit and the second magnetic unit may at least partially surround perimeters of the first accommodating portion and the second accommodating portion, respectively.

In some embodiments, the first pouch case and the second pouch case may be sealed to each other through four sides of the pouch, and the first magnetic unit and the second magnetic unit may extend along four sides of the first peripheral portion and the second peripheral portion, respectively, to surround the perimeters of the first accommodating portion and the second accommodating portion.

In some embodiments, the first pouch case and the second pouch case may be sealed to each other through three sides of the pouch, and the first magnetic unit and the second magnetic unit may extend along three sides of the first peripheral portion and the second peripheral portion, respectively, to partially surround the perimeters of the first accommodating portion and the second accommodating portion.

In some embodiments, the first magnetic unit and the second magnetic unit may include a metallic material.

In some embodiments, a thickness of the first magnetic unit or the second magnetic unit may be from 5 μm to 20 μm.

In some embodiments, the first magnetic unit and the second magnetic unit may have a closed ring shape or an open ring shape.

In some embodiments, the first magnetic unit may be formed on an outer surface of the first pouch case, and the second magnetic unit may be formed on an outer surface of the second pouch case.

In some embodiments, the first magnetic unit may be formed on an inner surface of the first pouch case, and the second magnetic unit may be formed on an inner surface of the second pouch case.

In some embodiments, the first magnetic unit and the second magnetic unit may be coupled to each other by an electromagnetic attraction.

In some embodiments, an electrode lead may be connected to the electrode assembly to be exposed to an outside of the pouch. The electrode lead may be fused together with the first peripheral portion of the first pouch case and the second peripheral portion of the second pouch case.

A battery system according to exemplary embodiments of the disclosed technology a plurality of battery cells, each of which comprising a pouch and an electrode assembly accommodated in the pouch, and a magnetic sensor. The pouch includes a first pouch case including a first peripheral portion and a first magnetic unit formed at the first peripheral portion, and a second pouch case including a second peripheral portion and a second magnetic unit formed at the second peripheral portion. The second magnetic unit has an opposite polarity from that of the first magnetic unit. The second pouch case is sealed with the first pouch case. The magnetic sensor is coupled to at least one battery cell of the plurality of battery cells to detect a change of a magnetic field generated from the first magnetic unit and the second magnetic unit. The magnetic sensor is adjacent to the first magnetic unit or the second magnetic unit at an outside of the pouch.

In some embodiments, the magnetic sensor may be configured to detect the change of the magnetic field caused when the first magnetic unit and the second magnetic unit are separated from each other due to a gas generated at an inside of the pouch.

A pouch for a lithium secondary battery according to embodiments of the disclosed technology may be formed by bonding a first pouch case including a first magnetic unit and a second pouch case including a second magnetic unit. An electromagnetic attraction may be created between the first magnetic unit and the second magnetic unit, and a peripheral portion of the first pouch case including the first magnetic unit and a peripheral portion of the second pouch case including the second magnetic unit may be more strongly bonded to each other by the electromagnetic attraction.

Additionally, the first magnetic unit and the second magnetic unit may be integrally coupled to generate a local magnetic field. When the first magnetic unit and the second magnetic unit are spaced apart, a change of a local magnetic field may be induced. Thus, excessive generation of gas and separation of a bonding region may be detected earlier based on the change of the local magnetic field. Further, ventilation a battery system or a battery cell may be detected and prevented.

### BRIEF DESCRIPTION OF THE DRAWINGS

FIGS. 1 and 2 are schematic perspective views illustrating a state before a pouch for a lithium secondary battery is sealed in accordance with exemplary embodiments.

FIGS. 3 and 4 are schematic perspective views illustrating a state after a pouch for a lithium secondary battery is sealed in accordance with exemplary embodiments.

FIGS. 5 and 6 are a schematic perspective view and a schematic cross-sectional view illustrating a state where a ventilation occurs in a pouch for a lithium secondary battery in accordance with exemplary embodiments.

FIG. 7 is a schematic perspective view illustrating a battery system including a lithium secondary battery in accordance with exemplary embodiments.

### DETAILED DESCRIPTION OF THE EMBODIMENTS

According to exemplary embodiments, a lithium secondary battery including a pouch that includes a magnetic unit. According to exemplary embodiments, a battery system including the lithium secondary battery is also provided.

The term “peripheral portion” as used herein may refer to regions in contact with each other among regions of first or second pouch cases. A region in which a first peripheral portion of the first pouch case and the second peripheral portion of the second pouch case are bonded to each other may be referred to as a “sealing region.” The first peripheral portion and the second peripheral portion may be formed symmetrically to each other.

The terms “outside” or “outer” as used herein may refer to a surface exposed to an outside of the pouch after the first pouch case and the second pouch case are bonded to form a single pouch.

The terms “inside” or “inner” as used herein may refer to a surface that is not exposed to the outside of the pouch after the first pouch case and the second pouch case are bonded to form a single pouch. For example, the terms “inside” or “inner” may be used to refer to an inner surface of each pouch case.

The term “closed” as used herein may refer to a state in which a region completely surrounded by a ring is formed. Thus, the term ‘closed ring shape’ may refer to a region completely surrounded by a boundary formed by the ring.

The term ‘open’ as used herein may refer to a state in which a region partially surrounded by a ring is formed. For example, the term “open ring shape” may refer to a shape in which at least portion of the ring is cut.

Hereinafter, the present invention will be described in detail with reference to the accompanying drawings. However, those skilled in the art will appreciate that such embodiments described with reference to the accompanying drawings are provided to further understand the spirit of the disclosed technology and do not limit subject matters to be protected as disclosed in this patent document.

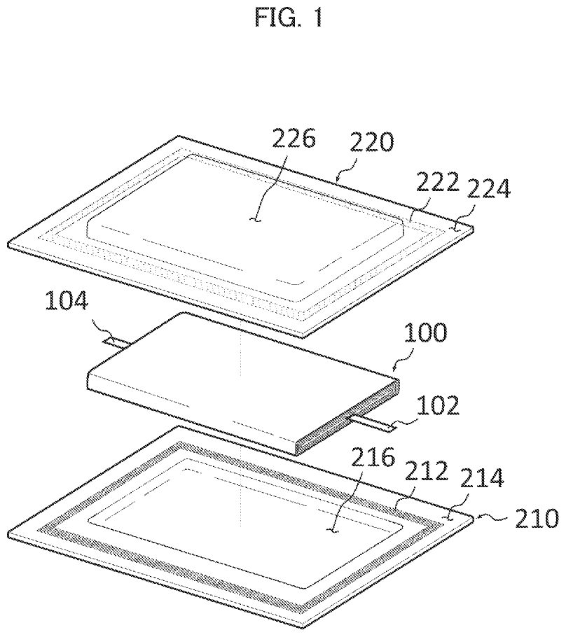

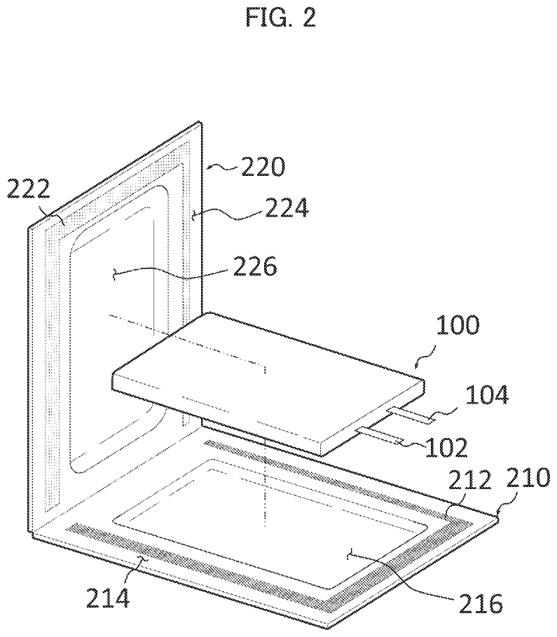

FIGS. 1 and 2 are schematic perspective views illustrating a state before a pouch for a lithium secondary battery is sealed in accordance with exemplary embodiments.

Referring to FIGS. 1 and 2, a pouch for a lithium secondary battery according embodiments of the disclosed technology includes a first pouch case 210 and a second pouch case 220, and outer shapes of the first pouch case 210 and the second pouch case 220 may be substantially the same. The first pouch case 210 includes a first accommodating portion 216 and a first peripheral portion 214 formed around the first accommodating portion 216. The second pouch case 220 includes a second accommodating portion 226 and a second peripheral portion 224 formed around the second accommodating portion 226.

A first magnetic unit 212 is formed at the first peripheral portion 214 of the first pouch case 210, and a second magnetic unit 222 is formed at the second peripheral portion 224 of the second pouch case 220. The first magnetic unit 212 may be formed to surround the first accommodating portion 216, and the second magnetic unit 222 may be formed to surround the second accommodating portion 226.

The first peripheral portion 214 and the second peripheral portion 224 may each include four sides around the accommodating portions 216 and 226. As illustrated in FIG. 1, the first magnetic unit 212 may be formed at four sides of the first peripheral portion 214, and the second magnetic unit 222 may be formed at four sides of the second peripheral portion 224.

As illustrated in FIG. 2, the first magnetic unit 212 may be formed at three sides of the first peripheral portion 214, and the second magnetic unit 222 may be formed at three sides of the second peripheral portion 224.

As illustrated in FIG. 1, both the first magnetic unit 212 and the second magnetic unit 222 may be formed in a closed ring shape. The first magnetic unit 212 and the second magnetic unit 222 may be formed symmetrically or asymmetrically with each other.

As illustrated in FIG. 2, both the first magnetic unit 212 and the second magnetic unit 222 may be formed in an open ring shape, and the first magnetic unit 212 and the second magnetic unit 222 may be formed symmetrically or asymmetrically with each other.

The lithium secondary battery may include a pouch formed by bonding the first pouch case 210 and the second pouch case 220 to each other, and an electrode assembly 100. The electrode assembly 100 may be accommodated in the pouch in accommodating portions 216 and 226.

In some embodiments, the first pouch case 210 and the second pouch case 220 may be disposed above and below the electrode assembly 100 in a state separated from each other. After receiving the electrode assembly 100 in the accommodating portions 216 and 226, the first pouch case 210 and the second pouch case 220 may be sealed using four sides of the first peripheral portion 214 and the second peripheral portion 224.

The electrode assembly 100 may include repeatedly stacked electrodes and a separation layer disposed between the electrodes. Each of the electrodes may include an active material layer formed on an electrode current collector. The electrodes may include an anode and a cathode.

The cathode may include a cathode current collector and a cathode active material layer formed by coating a cathode active material on the cathode current collector. The cathode active material may include a compound capable of reversibly intercalating and de-intercalating lithium ions.

In exemplary embodiments, the cathode active material may include lithium-transition metal composite oxide particles. For example, the lithium-transition metal composite oxide particles may be represented by Chemical Formula 1 below.

LiₓNi_{1-y}M_{y}O_{2-z}X_{z} [Chemical Formula 1]

In Chemical Formula 1, 0.9≤x−1.1, 0≤y≤0.7, and −0.1≤z≤0.1. M may represent at least one element selected from Na, Mg, Ca, Y, Ti, Zr, Hf, V, Nb, Ta, Cr, Mo, W, Mn, Co, Fe, Cu, Ag, Zn, B, Al, Ga, C, Si, Sn or Zr. X may represent at least one element selected from O, F, S and P.

In an embodiment, a molar ratio (1−y) of nickel in Chemical Formula 1 may be in a range from 0.8 to 0.95. In this case, power and capacity may be increased using a high-nickel (High-Ni) cathode composition.

Additionally, the lithium-transition metal composite oxide particles may be represented by Chemical Formula 2 below, and may have an olivine structure.

LiMPO₄ [Chemical Formula 2]

In Chemical Formula 2, M may be at least one element selected from Fe, Mn, Ni, Co and V.

The cathode current collector may include a metallic material that may not be reactive in a charge/discharge voltage range of the lithium secondary battery, and may be easily coated and adhered to the active material. For example, the cathode current collector may include, e.g., aluminum or an aluminum alloy.

A slurry may be prepared by mixing and stirring the cathode active material with a binder, a conductive material and/or a dispersive agent in a solvent. The slurry may be coated on the cathode current collector, and then dried and pressed to form the cathode including the cathode active material layer.

The binder may include an organic based binder or an aqueous based binder such as styrene-butadiene rubber (SBR) that may be used with a thickener such as carboxymethyl cellulose (CMC).

The conductive material may be added to facilitate electron mobility between active material particles. For example, the conductive material may include a carbon-based material such as graphite, carbon black, graphene, carbon nanotube, etc., and/or a metal-based material such as tin, tin oxide, titanium oxide, a perovskite material including, e.g., LaSrCoO₃, LaSrMnO₃, etc.

The anode may include an anode current collector and an anode active material layer formed by coating an anode active material on the anode current collector.

The anode active material may include a material commonly used in the related art which may be capable of adsorbing and ejecting lithium ions. For example, a carbon-based material such as a crystalline carbon, an amorphous carbon, a carbon complex or a carbon fiber, a lithium alloy, a silicon (Si)-based compound, etc., may be used.

In some embodiments, the anode active material may include the silicon-based active material to provide a high-capacity lithium secondary battery. The silicon-based active material may include SiOx (0<x<2) or SiOx (0<x<2) containing a lithium compound.

The anode current collector may include gold, stainless steel, nickel, aluminum, titanium, copper or an alloy thereof, preferably may include copper or a copper alloy.

For example, a slurry may be prepared by mixing and stirring the anode active material with a binder, a conductive material, a thickener, etc., in a solvent. The slurry may be coated on the anode current collector, and then dried and pressed to form the anode including the anode active material layer.

The binder and the conductive material substantially the same as or similar to those used for forming the cathode may be used in the anode.

The separation layer may be interposed between the cathode and the anode. The separation layer include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like.

In exemplary embodiments, an electrode cell may be defined by the cathode, the anode and the separation layer, and a plurality of the electrode cells may be stacked to form the electrode assembly. The battery cell may be accommodated together with an electrolyte in the pouch to define the secondary battery. In exemplary embodiments, a non-aqueous electrolyte may be used as the electrolyte.

The non-aqueous electrolyte solution may include a lithium salt and an organic solvent. The lithium salt may be represented by Li⁺X⁻, and an anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, etc. These may be used alone or in a combination of two or more therefrom.

A notched portion (not illustrated) may be formed from at least one end portion of the electrode current collector. The notched portion may serve as, e.g., an electrode tab. The notched portion may include a cathode notched potion (e.g., a cathode tab) protruding from the cathode current collector and an anode notched portion (e.g., an anode tab) protruding from the anode current collector.

The electrode tabs may be electrically connected to electrode leads 102 and 104 exposed to an outside of the pouch. The electrode leads may include a cathode lead 102 and an anode lead 104 connected to the cathode tab and the anode tab, respectively. To prevent an electrical short circuit, an insulating member (e.g., an insulating tape) may be formed on a partial region of each of the electrode leads 102 and 104.

As illustrated in FIG. 1, the cathode lead 102 and the anode lead 104 may be disposed at opposite sides of the electrode assembly 100.

As illustrated in 1, the electrode assembly 100 may have a wound type structure. The electrode assembly 100 may also have, e.g., a stacked structure or a jelly-roll structure by folding.

As illustrated in FIG. 2, the first pouch case 210 and the second pouch case 220 may be prepared as an integral member. In this case, the first pouch case 210 and the second pouch case 220 may be integrally connected at one side of each of the first peripheral portion 214 and the second peripheral portion 224. After accommodating the electrode assembly 100 in the accommodating portions 216 and 226, the first pouch case 210 and the second pouch case 220 may be sealed using remaining three sides of the first peripheral portion 214 and second peripheral portion 224.

Both the first magnetic unit 212 and the second magnetic unit 222 may have an open ring shape. The first magnetic unit 212 and the second magnetic unit 222 may be formed symmetrically with each other. In some embodiments, the cathode lead 102 and the anode lead 104 may be disposed at the same side of the electrode assembly 100.

As described above, the first magnetic unit 212 and the second magnetic unit 222 may be formed at partial regions of the peripheral portions 214 and 224 of each of the pouch cases 210 and 220. The magnetic units 212 and 222 may be formed at three sides of the peripheral portions 214 and 224 excluding one side at which the pouch cases are integrally connected among four sides. The three sides may form a sealing portion, and each of the electrode leads 102 and 104 may be fused together with the peripheral portions 214 and 224 of the first pouch case 210 and the second pouch case 220 at the sealing region.

In some embodiments, the first magnetic unit 212 and the second magnetic unit 222 may have the same shape and may be symmetrical to each other, and only one of the first pouch case 210 and the second pouch case 220 may have an accommodating portion for the electrode assembly 100. In this case, the pouch case that may not include the accommodating portion for the electrode assembly 100 may be prepared in a plate shape that does not include a region protruding to an outside.

Each of the pouch cases 210 and 220 may include an inner resin layer and an outer resin layer, and may further include a metal layer between the inner resin layer and the outer resin layer. The metal layer may include aluminum or an aluminum alloy. In this case, the thin type pouch cases 210 and 220 may be easily implemented, and heat resistance and mechanical durability of the pouch may be improved.

The magnetic units 212 and 222 may be included in the inner resin layer located at the peripheral portion of the pouch cases 210 and 220. In an embodiment, the magnetic units 212 and 222 may not be exposed in an inner direction of the pouch. In an embodiment, the magnetic units 212 and 222 may be exposed in the inner direction of the pouch.

The inner resin layer may include a polymer resin having enhanced electrolyte resistance. For example, the inner resin layer may include a polyolefin resin, a copolymer of ethylene and an acrylic acid, a copolymer of propylene and an acrylic acid, etc. Examples of the polyolefin resin may include unstretched polypropylene, polypropylene-butylene-ethylene terpolymer, polypropylene, a chlorinated polypropylene (CPP) resin, polyethylene, ethylene propylene copolymer, etc.

The outer resin layer may include, e.g., polyethylene, polypropylene, polyethylene terephthalate, nylon, a low density polyethylene (LDPE), a high density polyethylene (HDPE), a linear low density polyethylene (LLDPE), etc. These may be used alone or in a combination thereof.

Each thickness of the inner resin layer or the outer resin layer may be from 5 μm to 100 μm, e.g., from 10 μm to 80 μm.

In some embodiments, the magnetic units 212 and 222 included in each of the pouch cases 210 and 220 may be located at an outer side of the external resin layer. In this case, the magnetic units 212 and 222 may not directly contact each other. Additionally, a magnitude of a magnetic field generated by the magnetic units facing each other may be relatively reduced when compared to a case in which the magnetic units 212 and 222 are included in the internal resin layer,

The magnetic units 212 and 222 may include a magnetic material, e.g., a metallic material. For example, when a magnetic field is measured through a standard magnetic measurement technique, the material may be regarded as having magnetic properties.

The metallic material may include a rare earth-based material, a cobalt-based material, a nickel-based material, a metal oxide-based material, etc. In an embodiment, iron or an iron alloy may be used as the metallic material. In an embodiment, the magnetic material may include a cobalt-iron alloy, silicon steel, stainless steel or a combination thereof.

A thickness of the magnetic unit 212 and 222 may be in a range from 5 μm to 20 μm. In the above thickness range, the change of the magnetic field generated by the magnetic units 212 and 222 may be precisely detected by a magnetic sensor, and irregularities may not be caused in the peripheral portions 214 and 224 of the pouch cases 210 and 220.

For example, the magnetic units 212 and 222 may be attached to an inside or an outside of the peripheral portions 214 and 224 of the pouch cases 210 and 220 using an adhesive or through a thermal fusion process.

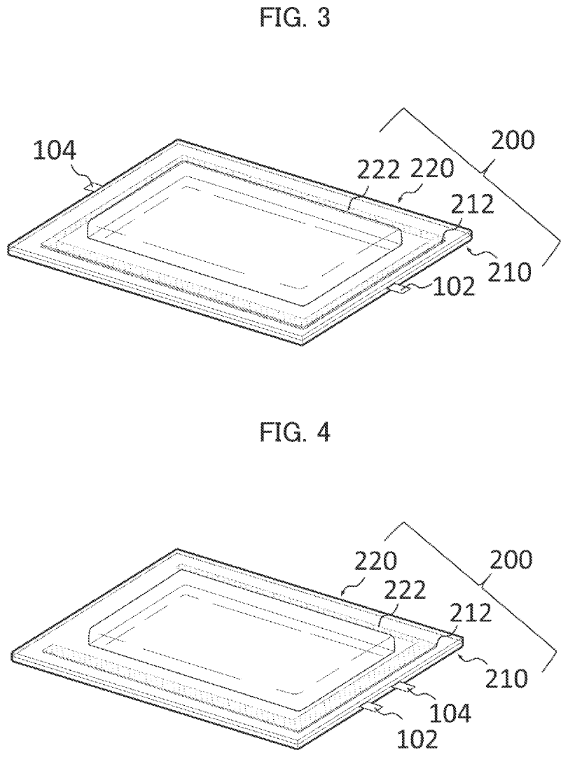

FIGS. 3 and 4 are schematic perspective views illustrating a state after a pouch for a lithium secondary battery is sealed in accordance with exemplary embodiments.

Referring to FIGS. 3 and 4, the first peripheral portion 214 of the first pouch case 210 and the second peripheral portion 224 of the second pouch case 220 may be bonded to form the sealed pouch 200.

The first magnetic unit 212 and the second magnetic unit 222 may be disposed to face each other. In exemplary embodiments, the first magnetic unit 212 and the second magnetic unit 222 may have opposite polarities. The term “opposite polarity” as used herein may refer to a magnetization in opposite directions. The first magnetic unit 212 and the second magnetic unit 222 may be magnetized in opposite directions, so that an electromagnetic attraction may be generated between the first magnetic unit 212 and the second magnetic unit 222.

The peripheral portions 214 and 224 of the pouch 200 may be more strongly sealed due to the electromagnetic attraction, and thus ventilation due to separation of the pouch cases 210 and 220 may be delayed or suppressed.

In some embodiments, the first magnetic unit 212 and the second magnetic unit 222 may form a magnetic field as an integra member. For example, the first magnetic unit 212 may provide an N pole and the second magnetic unit 222 may provide an S pole. Alternatively, the first magnetic unit 212 may provide an S pole and the second magnetic unit 222 may provide an N pole. The magnetic field may be locally formed by the first magnetic unit 212 and the second magnetic unit 222 magnetized in opposite directions.

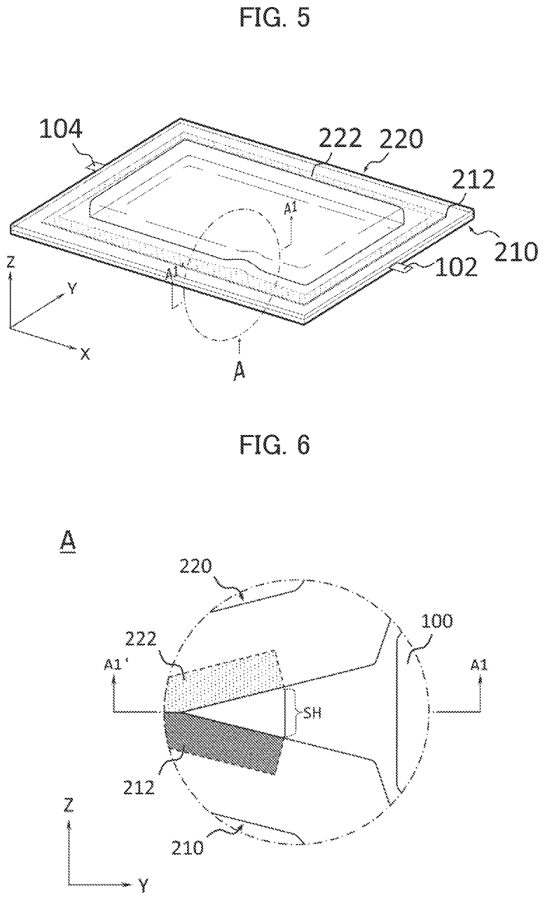

FIGS. 5 and 6 are a schematic perspective view and a schematic cross-sectional view illustrating a state where a ventilation occurs in a pouch for a lithium secondary battery in accordance with exemplary embodiments. FIG. 6 is an enlarged view of a region A of FIG. 5 taken along a direction designated as A1-A1′ (a direction parallel to a Y-axis).

Referring to FIGS. 5 and 6, a separation of the first magnetic unit 212 and the second magnetic unit 222 may occur in advance to a complete ventilation of the pouch 200. Accordingly, as illustrated in FIG. 6, a separation height SH may be generated between the first magnetic unit 212 and the second magnetic unit 222.

When the separation occurs between the first magnetic unit 212 and the second magnetic unit 222, a strength of the magnetic field generated by the first magnetic unit 212 and the second magnetic unit 222 may be changed.

As the spaced height SH increases, the change of the magnetic field generated by the first magnetic unit 212 and the second magnetic unit 222 may increase. For example, the magnetic field may be changed due to a change of an arrangement direction of a flux constituting the magnetic field or a change of the strength of the magnetic field.

The change of the magnetic field strength may be detected by a magnetic sensor located at the outside of the pouch 200. The magnetic sensor may detect the change of the magnetic field generated by the first magnetic unit 212 and the second magnetic unit 222, thereby measuring an expanded area and a degree of the expansion at the inside of the pouch 200.

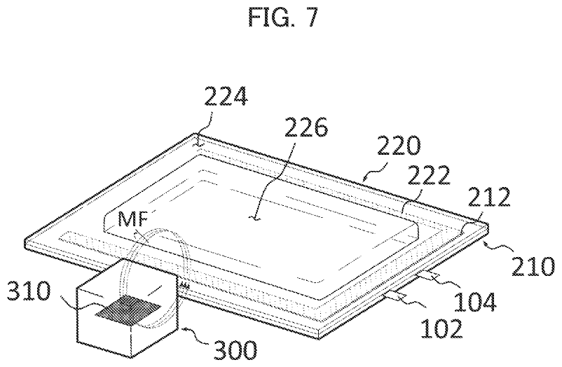

FIG. 7 is a schematic perspective view illustrating a battery system including a lithium secondary battery in accordance with exemplary embodiments.

The battery system may include a plurality of battery cells each including the pouch 200 and the electrode assembly 100 according to the above-described embodiments, and may further the magnetic sensor 300. At least one battery cell among the plurality of battery cells may be adjacent to a magnetic sensor 300 disposed at the outside of the pouch 200 to detect the change of the magnetic field generated from the magnetic units 212 and 222.

In some embodiments, the magnetic sensor 300 may be a Hall sensor capable of detecting the change of the magnetic field based on a Hall effect. The Hall sensor may include a sensing unit 310 having a conductivity.

For example, a portion of the magnetic field MF generated by a combination of the first magnetic unit 212 and the second magnetic unit 222 may pass through the sensing unit 310 included in the magnetic sensor 300. Accordingly, a current may be induced in the sensing unit 310 to detect the change of the strength or the direction of the magnetic field.

Based on the change of the magnetic field sensed by the magnetic sensor 300, the separation between the first magnetic unit 212 and the second magnetic unit 222 may be detected, and a separation height SH may be calculated. Accordingly, the expansion of the pouch according to the generation of gas may be detected at an early phase, and an expanded region and the degree of expansion may be specified before the complete ventilation of the battery cell occurs.

What is claimed is:

1. A lithium secondary battery, comprising:
a pouch comprising:
a first pouch case comprising a first peripheral portion and a first magnetic unit formed at the first peripheral portion; and
a second pouch case comprising a second peripheral portion and a second magnetic unit formed at the second peripheral portion, the second magnetic unit having an opposite polarity from that of the first magnetic unit, the second pouch case being sealed with the first pouch case; and
an electrode assembly accommodated in the pouch.

2. The lithium secondary battery of claim 1, wherein the first pouch case and the second pouch case are combined with each other so that the first magnetic unit and the second magnetic unit face each other.

3. The lithium secondary battery of claim 1, wherein the first pouch case and the second pouch case comprise a first accommodating portion and a second accommodating portion, respectively, which protrude to an outside of the pouch to accommodate the electrode assembly.

4. The lithium secondary battery of claim 3, wherein the first magnetic unit and the second magnetic unit at least partially surround perimeters of the first accommodating portion and the second accommodating portion, respectively.

5. The lithium secondary battery of claim 4, wherein the first pouch case and the second pouch case are sealed to each other through four sides of the pouch, and
the first magnetic unit and the second magnetic unit extend along four sides of the first peripheral portion and the second peripheral portion, respectively, to surround the perimeters of the first accommodating portion and the second accommodating portion.

6. The lithium secondary battery of claim 4, wherein the first pouch case and the second pouch case are sealed to each other through three sides of the pouch, and
the first magnetic unit and the second magnetic unit extend along three sides of the first peripheral portion and the second peripheral portion, respectively, to partially surround the perimeters of the first accommodating portion and the second accommodating portion.

7. The lithium secondary battery of claim 1, wherein the first magnetic unit and the second magnetic unit include a metallic material.

8. The lithium secondary battery of claim 1, wherein a thickness of the first magnetic unit or the second magnetic unit is from 5 μm to 20 μm.

9. The lithium secondary battery of claim 1, wherein the first magnetic unit and the second magnetic unit have a closed ring shape or an open ring shape.

10. The lithium secondary battery of claim 1, wherein the first magnetic unit is formed on an outer surface of the first pouch case, and the second magnetic unit is formed on an outer surface of the second pouch case.

11. The lithium secondary battery of claim 1, wherein the first magnetic unit is formed on an inner surface of the first pouch case, and the second magnetic unit is formed on an inner surface of the second pouch case.

12. The lithium secondary battery of claim 1, wherein the first magnetic unit and the second magnetic unit are coupled to each other by an electromagnetic attraction.

13. The lithium secondary battery of claim 1, further comprising an electrode lead connected to the electrode assembly to be exposed to an outside of the pouch,
wherein the electrode lead is fused together with the first peripheral portion of the first pouch case and the second peripheral portion of the second pouch case.

14. A battery system, comprising:
a plurality of battery cells, each of which comprising:
a pouch comprising:
a first pouch case comprising a first peripheral portion and a first magnetic unit formed at the first peripheral portion; and
a second pouch case comprising a second peripheral portion and a second magnetic unit formed at the second peripheral portion, the second magnetic unit having an opposite polarity from that of the first magnetic unit, the second pouch case being sealed with the first pouch case; and
an electrode assembly accommodated in the pouch; and
a magnetic sensor coupled to at least one battery cell of the plurality of battery cells to detect a change of a magnetic field generated from the first magnetic unit and the second magnetic unit, the magnetic sensor being adjacent to the first magnetic unit or the second magnetic unit at an outside of the pouch.

15. The battery system of claim 14, wherein the magnetic sensor is configured to detect the change of the magnetic field caused when the first magnetic unit and the second magnetic unit are separated from each other due to a gas generated at an inside of the pouch.
